(19) United States
(12) Patent Application Publication
(10) Pub. No.: US 2026/0186180 A1
(43) Pub. Date: Jul. 2, 2026

(54) Diffractive Lenses Containing Subwavelength Structures and Design Technique

(71) Applicants: Yakov Soskind, Plainsboro, NJ (US); Michael Soskind, Plainsboro, NJ (US)

(72) Inventors: Yakov Soskind, Plainsboro, NJ (US); Michael Soskind, Plainsboro, NJ (US)

(21) Appl. No.: 19/006,489

(22) Filed: Dec. 31, 2024

(51) Int. Cl. G02B 5/18

(52) U.S. Cl. CPC G02B 5/1847; G02B 5/1814

(57) ABSTRACT

A diffractive lens comprises different arrays of multiple sub-wavelength structures of different shapes and sizes. A technique of designing diffractive lenses includes: (a) analyzing the lens requirements, (b) selecting the lens substrate and subwavelength structure materials, (c) dividing the lens phase profile into individual phase regions that produce optical path transitions with neighboring phase regions which are integer multiples of the operating wavelength, (d) calculating the regions' spacings along the local phase gradients' directions, (e) defining arrays of subwavelength structures having lengths corresponding to the regions' spacings along the local phase gradients, (f) optimizing arrays of the subwavelength structures, i.e. defining the optimum the number of subwavelength structures within the arrays, their relative placement within the arrays, their shapes and sizes, and optimum array widths in the direction orthogonal to arrays' lengths, and (g) creating the lens layout by arranging the optimized arrays within the lens phase regions,

### FIELD OF THE INVENTION

The present invention relates to the field of optical design of diffractive phase lenses. More specifically, the invention relates to design and construction of diffractive phase lens elements composed of sub-wavelength structures, also referred to as metalenses, where arrangements of the subwavelength structures are optimized to produce high focusing efficiencies and enhanced manufacturability.

### BACKGROUND OF THE INVENTION

Diffractive lenses represent two-dimensional phase structures that constitute an important class of diffractive optical elements used in a variety of optical devices and photonics instruments, including spectrometers, tunable laser systems, laser pulse compressors, wavelength division multiplexers, etc. Diffractive lenses are composed of phase regions, where each region boundary corresponds to an optical path transition of +/−mλ, where m is the working diffraction order and λ is the operating wavelength. Each phase region has a specific phase profile (Y. Soskind, “Field Guide to Diffractive Optics”, SPIE Press, 2011, page 92) that introduces controlled phase delays to the propagating light. In other words, the phase regions introduce an optical path difference of +/−2mπ radians to the operating wavelength λ. Often the working diffraction order is selected to be m=+/−1, i.e. each region diffracts light into the +1^{st} or −1^{st} diffraction order. Diffractive phase regions can be designed using the local grating approximation (B. Kress and P. Meyrueis, “Digital Diffractive Optics. An Introduction to Planar Diffractive Optics and Related Technology”, John Wiley & Sons, 2000, pp. 119-120), when each phase region profile is defined as a blazed grating structure or its multi-level binary approximation that match the desired phase delays produced by each phase region.

Diffractive lenses designed using blazed phase profiles or their multi-step binary approximations become less efficient with the increase in lens' numerical apertures, when the number of the phase regions within the lens is increased while the respective region widths with respect to the operating wavelength λ are decreased. Reduction in the lens efficiency results in a reduced fraction of incident light being directed into the working diffraction order and the associated increase in the fraction of light diffracted into the spurious orders. A reduction in diffraction efficiencies is especially pronounced in the rigorous domain of diffraction, when the gratings' periods d become small, satisfying the relation d≤10λ. In the case of diffractive focusing lenses, a reduction in diffraction efficiency results in less light being collected within the focal spot of the lens. Fabrication of blazed phase profiles and their multi-step binary approximations often requires complex manufacturing processes composed of multiple lithography steps.

Traditional diffractive blazed phase profiles and their binary approximations can be replaced with periodic arrangements of subwavelength structures fabricated on a supporting substrate. The subwavelength structures are produced using well established and scalable fabrication processes, such as photolithography or nano-imprint. The subwavelength structures can be made of different materials and can assume different shapes and sizes, such as islands, posts or holes. Cross-sections of the subwavelength structures may take different shapes and sizes, including circles, ellipses, polygonal shapes, and general curvilinear shapes. Fabricated subwavelength structures may also have wall slopes that change their cross-sections along their heights.

Diffractive phase lenses composed of subwavelength structures are often referred to as meta-lenses. They are traditionally constructed by populating the lens phase regions with periodically spaced subwavelength structures, where the subwavelength structures introduce localized phase delays intended to match the respective phase values within the lens regions. The phase delays of the subwavelength structures are often defined using the periodic cell approximation (PCA) technique, as described for example in [S.-W. Moon, et al. “Tutorial on metalenses for advanced flat optics: design, fabrication, and critical considerations.” Journal of Applied Physics 131.9 (2022)]. PCA implies that the phase delays produced by individual sub-wavelength structures can be obtained from phase delays produced by periodic arrays of identical sub-wavelength structures. PCA-based phase delays depend on the material properties and geometrical characteristics of the periodically spaced subwavelength structures, such as their shapes, sizes and periodic spacings.

Designs of lenses containing subwavelengths structures have been described in the past. US Patent Application 2023/0176366 “System and Method Designing Metalens” describes design of meta-lenses using the PCA approach employing nanostructures with varying width W positioned at periodic lateral pitch values P. The lens phase profile is divided into individual phase regions. Each phase region is populated with nanostructures spaced on a square grid with pitch P, where the widths W of the individual nanostructures are calculated using the PCA technique. The width W and pitch P values are further adjusted within a limited local range to further improve transmission through the nanostructures. While offering limited performance improvements with respect to PCA designs, this design approach does not lend itself to high diffraction efficiency lens solutions, especially in lenses with higher numerical apertures.

Another US Patent Application 2023/0367114 “Automated Metalens Design System” describes a meta-lens design approach, where the subwavelength structures (meta-atoms) are similarly positioned on a constant square grid with respect to each other, and the size of the individual meta-atoms is selected from a database library. The database library is generated employing the PCA approach. The system further applies adjoint optimization processes to the lens as a whole by adjusting the widths or diameters of the meta-atoms within the lens in an attempt to further improve the lens performance. While offering some performance improvements with respect to PCA designs, this design approach does not result in high diffraction efficiency lens solutions, especially in lenses with high numerical apertures.

Convergence of the adjoint optimization process depends on the selection of the design starting point. However, the optimized lens performance, such as the lens absolute focusing efficiency, may not reach high values [M. Chalony, et al. “Optical and manufacturing design aware flow for metalenses.” Advanced Materials, Biomaterials, and Manufacturing, Technologies for Security and Defence. Vol. 12741. SPIE, 2023 and L. S. Melvin III, et al. “Metalens manufacturing complexities and costs.” Advanced Etch Technology and Process Integration for Nanopatterning XIII. Vol. 12958. SPIE, 2024].

A significant reduction in metalens focusing efficiency with the increase in lens numerical aperture was also demonstrated by Egede Johansen, et al. [V. Egede Johansen, et al., “Nanoscale precision brings experimental metalens efficiencies on par with theoretical promises.” Communications Physics 7.1 (2024): 123].

Therefore, it is desirable to establish metalens design techniques and to provide metalens designs that will result in higher diffraction efficiencies, especially for lenses with high numerical apertures and smaller region widths.

### SUMMARY OF THE INVENTION

In view of the foregoing, one object of the present invention is to establish design techniques of diffractive phase lenses containing subwavelength structures capable of producing high efficiency lenses, including lenses with high numerical apertures.

Another object of the present invention is to provide designs of high efficiency diffractive phase lenses containing subwavelength structures, including lenses with high numerical apertures.

Another object of the present invention is to provide designs of high efficiency diffractive phase lenses that can be designed as polarization-independent solutions, or can be optimized for a specific polarization state of incident light.

Still another object of the present invention is to provide designs of high efficiency diffractive phase lens designs with improved manufacturability.

Diffractive lenses containing subwavelength structures in accordance with the present invention are constructed from individual phase regions, where each phase region is composed of two-dimensional arrays of subwavelength structures optimized for high diffraction efficiency and manufacturability. Optical path transitions at the regions' boundaries equal to an integer multiple m of the operating wavelengths λ, therefore producing phase transitions 2mπ radians for the operating wavelength λ at the boundaries of the neighboring regions. The integer m is often selected to be m=1, resulting in optical phase differences at the boundaries of the regions equal 2π radians. The number of subwavelength structures contained within the arrays, the sizes, shapes and relative distances between the subwavelength structures within the arrays may differ between the phase regions and within the regions. Optimized arrays of subwavelength structures are aligned within each phase region with their lengths oriented along the directions of the local phase changes, i.e. directions of the phase gradients, and are spaced laterally at distances approximating the optimized arrays' widths. The lengths of the arrays is equal to the phase regions' dimensions measured along the local phase gradients.

For lenses with axial symmetry, the lens phase regions are ring-shaped and are centered with respect to the lens axis. Optimized arrays of subwavelength structures are oriented within the phase regions towards the center, with their lengths along radial directions, and are spaced tangentially at distances approximating their widths. Arrays' lengths within each phase region equal to the radial size of the phase region.

FIG. 1 presents a flow diagram of a design technique in accordance with the present invention. The design technique is comprised of multiple steps. (a) Analysis of the diffractive lens requirements, including the lens properties, such as the lens focal length, aperture size, operating wavelength, angles of incidence, desired focusing efficiency, acceptable back-reflection, etc. The lens requirements may also include restrictions to the amounts of light diffracted into the spurious diffraction orders, as well as fabrication considerations, such as the minimum feature sizes of the sub-wavelength structures, and the minimum gaps between the sub-wavelength structures. (b) Selection of the lens substrate and the subwavelength structures' layer materials and thicknesses. The subwavelength structures' layer thickness defines the heights of the sub-wavelength structures within the arrays. (c) Division of the lens phase profile into individual phase regions, where the phase transitions at the boundaries of phase regions are an integer multiple of 2π radians. (d) Determining the phase regions' dimensions along local phase gradients. (e) Defining multiple arrays with subwavelength structures whose lengths equal the phase regions' dimensions along the local phase gradients. The arrays may contain different numbers and different spatial arrangements of sub-wavelength structures. (f) Optimizing arrays with subwavelength structures and different lengths to satisfy performance and manufacturability requirements. Optimization techniques and array structures defined in U.S. patent application Ser. No. 18/919,973, filed on Oct. 24, 2024, which is hereby incorporated by reference in its entirety, can be used during the optimization process. (g) Selecting optimized arrays that best satisfy desired performance and manufacturability requirements. (h) Creating the lens layout by populating the lens phase regions with optimized arrays containing subwavelength structures by placing arrays within phase regions aligned with their lengths along the phase gradient directions and spacing arrays within phase regions orthogonal to the directions of the phase gradients at distances approximating optimum arrays' widths.

The presented design technique can be applied to design diffractive lenses optimized to work with polarized or un-polarized incident light. Lenses designed for un-polarized light contain optimized arrays of subwavelength structures with diffraction efficiencies that do not depend on the polarization state of incident light. For axially-symmetric lenses optimized for un-polarized light, the optimized arrays are aligned within each phase region with their lengths oriented along the radial directions and are arranged tangentially at equal azimuthal angular intervals corresponding to tangential spacings between the neighboring arrays approximating the optimized arrays' widths.

Lenses designed to work with preferentially polarized incident light, such as plane-polarized light or elliptically polarized light, contain optimized arrays of subwavelength structures with diffraction efficiencies that depend on the relative arrays' azimuthal orientation with respect to the incident light polarization. In that case, the optimized arrangements of subwavelength structures within the arrays and the optimized widths of the arrays will become a function of the arrays' azimuthal orientations with respect to the incident light. The optimized arrays will be also aligned within each lens phase region with their lengths oriented along the radial directions, while their layouts, azimuthal angular intervals and the respective tangential spacings of the optimized arrays will depend on polarization properties of the incident light. An additional increase in lens diffraction efficiency can be achieved with preferentially polarized incident light, as will be shown in the following embodiments.

Objectives of the present invention, including details of designing diffractive lenses composed of optimized arrays of subwavelength structures, are achieved in accordance with the following implementation technique and design examples, as will be explained in detail in the following illustrative embodiments.

The features of the present invention, including the construction and operational details of the illustrative embodiments, will be described in reference to the accompanying drawings.

### BRIEF DESCRIPTION OF THE DRAWINGS

FIG. 1 presents a flow diagram of the design technique in accordance with the present invention.

FIG. 2 presents a schematic view of the diffractive phase lens of the first embodiment

FIG. 3 presents the radial phase profile of the diffractive phase lens as a function of the lens radial coordinate

FIG. 4 presents the two-dimensional distribution of the diffractive lens phase regions of the first embodiment

FIG. 5 presents the radial cross-sections of the lens phase regions as a function of the lens radial coordinate.

FIG. 6 presents the lens phase regions' widths as a function of the radial coordinate.

FIG. 7 presents the lens relative phase regions' widths as a function of the region's number.

FIG. 8 presents a schematic layout of a phase region populated with arrays of subwavelength structures.

FIG. 9 presents the changes in arrays' lateral spacings within the phase regions as a function of the phase region number.

FIG. 10 presents changes in averaged absolute diffraction efficiencies of optimized arrays as a function of the array's width.

FIG. 11 presents changes in averaged normalized diffraction efficiencies of optimized arrays as a function of the array's width.

FIG. 12 presents an X-Y view of a diffractive lens where the phase regions of the lens are populated with optimized arrays of subwavelength structures.

FIG. 13 presents a fragment of the lens in FIG. 12, showing the phase regions of the lens populated with optimized arrays containing different arrangements of subwavelength structures.

FIG. 14 presents the relative contributions of the lens phase regions to the integral diffraction efficiency of the lens as a function of the region number.

FIG. 15 presents a two-dimensional phase distribution in the X-Y plane of a diffractive phase lens, when the lens aperture is offset from the center of the phase distribution.

FIG. 16 presents a two-dimensional distribution of the lens phase regions in the X-Y plane, when the lens aperture is offset from the center of the phase distribution.

FIG. 17 presents changes in diffraction efficiencies of different optimized arrays of subwavelength structures as a function of azimuthal angle.

FIG. 18 presents a schematic layout in the X-Y plane for a phase region optimized for polarized incident light.

FIG. 19 presents an X-Y view of a diffractive lens where the central region of the lens does not contain subwavelength structures.

FIG. 20 presents a two-dimensional phase profile in the X-Y plane for a diffractive phase lens with no axial symmetry.

FIG. 21 presents a two-dimensional distribution in the X-Y plane for phase regions of a diffractive lens without axial symmetry.

FIG. 22 presents a smaller area of the phase regions in the X-Y plane.

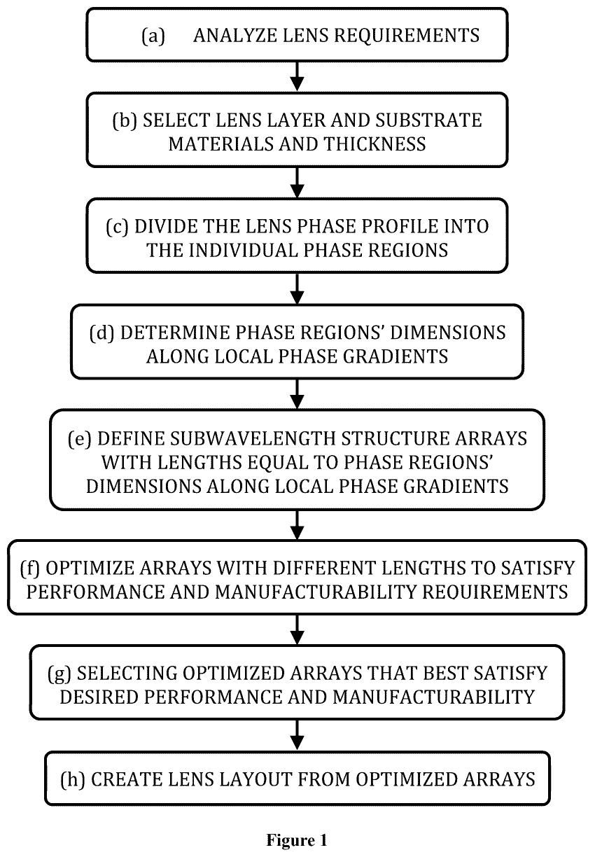

### DETAILED DESCRIPTION

The present invention is further described in detail in the form of the specific embodiments. However, the present invention is not limited to only the specific embodiment described herein, and can be employed with a broad range of modifications to the disclosed embodiment. For example, different types of materials can be used to fabricate diffractive lenses, including the lens substrate, the subwavelength structures, etch stop layers between the subwavelength structures and the substrate, coatings to match effective indices of the subwavelength structures to the substrate, etc. Materials' selection will affect the optimum number of the subwavelength structures contained within the arrays, the subwavelength structures' shapes and sizes. The subwavelength structures can be also encapsulated in a lower refractive index material, rather than being surrounded by air, to protect them from contamination and damage. Encapsulation material properties will also influence the optimum number of subwavelength structures within the arrays, the heights, cross-sectional shapes and sizes of the subwavelength structures. The lens design technique described herein can be used to produce diffractive lenses optimized for different spectral regions, polarization states, and angles of incident light.

Aspects of the present invention will be further described in the following embodiments.

### Embodiment 1

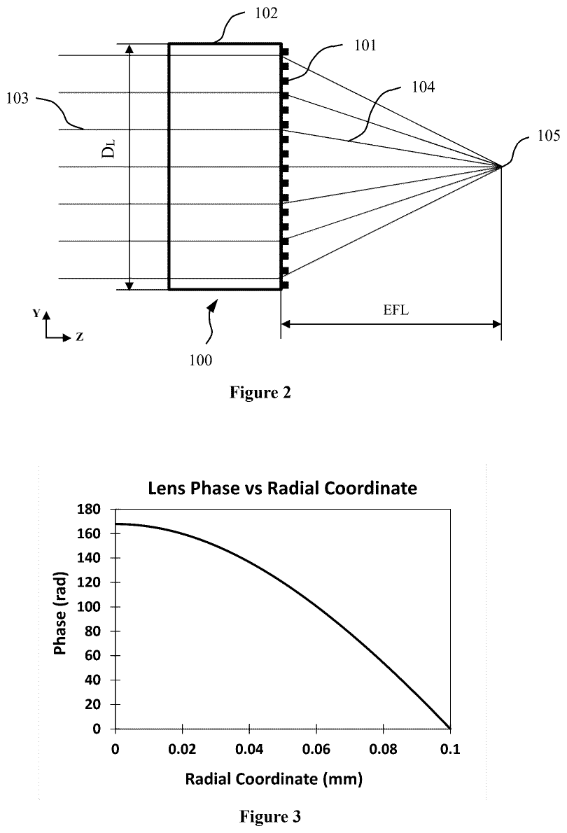

The first embodiment describes design of a diffractive phase lens containing subwavelength structures that can focus collimated incident light, or collimate light emerging from a point source. The lens is designed to be polarization-independent, i.e. the lens diffraction efficiency has minimal dependence on the polarization state of incident light. FIG. 2 presents a schematic view in the Y-Z plane of a Cartesian coordinate system for an axially-symmetric diffractive phase lens 100 of the first embodiment that is focusing incident collimating light 103. The lens 100 is composed of a layer 101 containing subwavelength structures fabricated onto a supporting structure 102. In the specific embodiments, the layer 101 is made of Si, and the substrate 102 is made of SiO₂. Lens 100 is designed for operation at a wavelength of λ=1.55 microns, and has effective focal length EFL=0.1 mm, and aperture diameter D_{L}=0.1 mm. After propagation through the layer containing subwavelength structures 101, the light 104 converges into the focal spot 105.

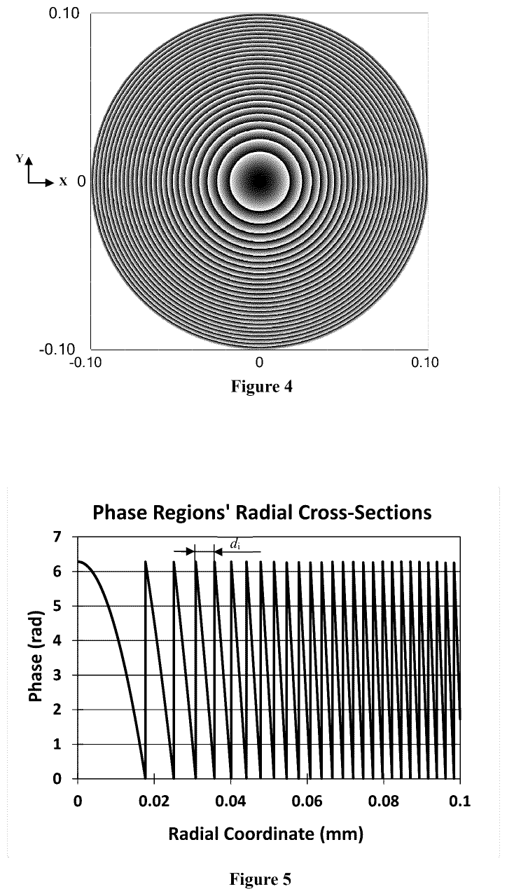

FIG. 3 presents the continuous radial phase profile, also known as an un-wrapped phase profile, as a function of the radial coordinate for a focusing phase lens that has effective focal length EFL=0.1 mm. The maximum phase change over the lens aperture is about 168 radians. Diffractive phase lenses are not capable of producing continuous phase profiles of this magnitude, and their phase profiles are composed of individual phase regions with precisely controlled and limited amounts of phase changes across the regions. FIG. 4 presents a two-dimensional distribution of phase regions in X-Y plane of the coordinate system, also known as a “wrapped” phase distribution, for the diffractive lens 100 shown in FIG. 2 over the lens aperture diameter of 0.1 mm. Phase transition occurs over the boundary of each phase region, where the optical phase changes discretely by 2π radians for the operating wavelength λ. FIG. 5 presents the radial cross-section of the phase profile for the diffractive lens 100 shown in FIG. 2, where the width of an i^{th} region is denoted as dᵢ.

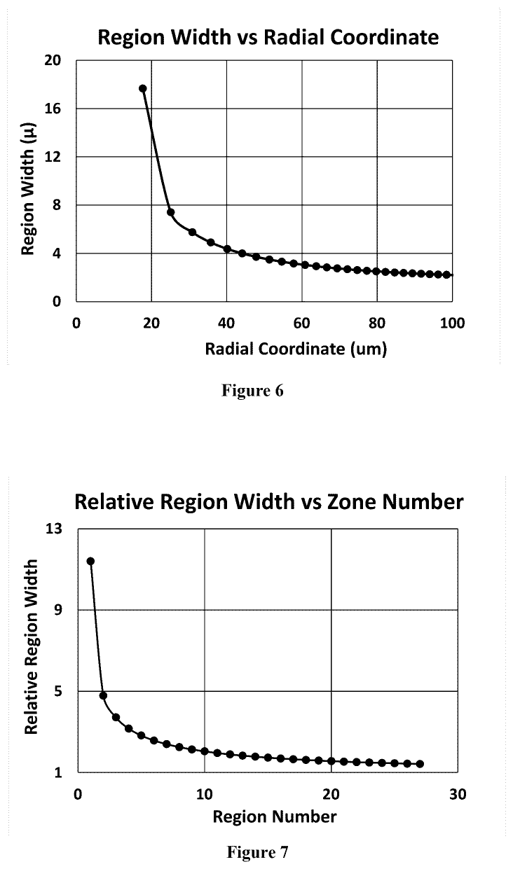

The phase regions' widths dᵢ gradually decrease with the increase in radial distance from the lens center. FIG. 6 presents the phase regions' widths in microns as a function of the radial coordinate for the diffractive lens of the first embodiment. The lens has a total of 27 phase regions across the lens aperture of 0.1 mm diameter. The central lens phase region is circular in shape, and has a radius of about 17.7 microns. The rest of the phase regions have annular shapes with progressively reduced radial widths wᵢ. The outer-most region 27 has the smallest radial width of about 2.2 microns or about 1.42λ. FIG. 7 presents relative region's widths for the diffractive lens in FIG. 2 with respect to the operating wavelength λ=1.55 microns, shown as a function of the region's number. Except for the circular central phase region, the relative widths of the annular phase regions dᵢ/λ<5, i.e. the regions' width correspond to the relative sizes typical of the rigorous diffraction domain.

Table 1 provides radial widths of the lens phase regions.

TABLE 1

| Region number | Radial width (μ) |
|---|---|
| 1 | 17.68 |
| 2 | 7.42 |
| 3 | 5.76 |
| 4 | 4.91 |
| 5 | 4.37 |
| 6 | 3.99 |
| 7 | 3.71 |
| 8 | 3.49 |
| 9 | 3.31 |
| 10 | 3.16 |
| 11 | 3.04 |
| 12 | 2.93 |
| 13 | 2.84 |
| 14 | 2.76 |
| 15 | 2.69 |
| 16 | 2.62 |
| 17 | 2.56 |
| 18 | 2.51 |
| 19 | 2.46 |
| 20 | 2.42 |
| 21 | 2.38 |
| 22 | 2.34 |
| 23 | 2.31 |
| 24 | 2.28 |
| 25 | 2.25 |
| 26 | 2.22 |
| 27 | 2.22 |

Improved focusing efficiencies and enhanced manufacturability of the diffractive lenses are achieved by employing optimized arrays of subwavelength structures to construct the lens phase profiles, rather than individual subwavelength structures as is commonly used with alternative design techniques.

Design and optimization technique of the two-dimensional arrays of subwavelength structures used to construct high efficiency lenses of the present invention have been described in the aforementioned U.S. patent application Ser. No. 18/919,973, filed on Oct. 24, 2024.

The optimized arrays of subwavelength structures achieve high diffraction efficiencies by accounting for electro-magnetic field interactions between neighboring subwavelength structures that influence propagation of light through the subwavelength structures. The highest diffraction efficiencies are achieved by selecting an optimum number of individual subwavelength structures within the arrays, by optimizing the relative placement of the subwavelength structures within the arrays, and by optimizing the lateral dimensions of the individual subwavelength structures within the arrays.

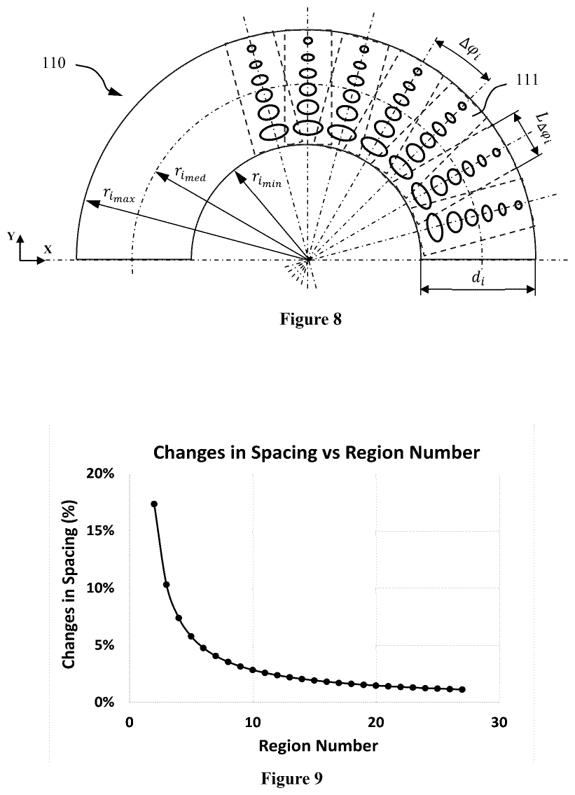

Construction of the individual phase regions from the respective optimized arrays of subwavelength structures needs to take into consideration the optimum widths L_{Y} of the arrays. In accordance with the present invention, individual phase regions are composed of the optimized individual arrays that are arranged azimuthally within the phase region 110 in the X-Y plane of the Cartesian coordinate system, as is shown schematically in FIG. 8. The optimized arrays 111 are spaced tangentially at a distance L_{Δφ}_{ᵢ} from each other along the median radius rᵢ_{_{med}} of the phase region 110. The median radius rᵢ_{_{med}} is defined as:

$${r}_{{i}_{m e d}} = ( {r}_{{i}_{max}} + {r}_{{i}_{min}} ) / 2 \qquad ( 1 )$$

where rᵢ_{ₘᵢₙ} and rᵢ_{ₘₐₓ} are the inner region radius and outer region radius, respectively.

Distance dᵢ between the phase regions that neighbor region 110 is defined as:

$${d}_{i} = ( {r}_{{i}_{max}} - {r}_{{i}_{min}} ) \qquad ( 2 )$$

Each optimized array has an optimum lateral width L_{Y}, that results in the highest diffraction efficiency. The optimized arrays are arranged within each phase region 110 azimuthally at equal angular intervals. The angular spacings Δφᵢ are chosen to provide linear separation L_{Δφ}_{ᵢ} of the arrays tangential to the median radius rimed to closely approximate the optimum array width L_{Y}, i.e. L_{Δφ}_{ᵢ}≈L_{Y}. The number of arrays N_{MM}_{ᵢ} arranged within the i^{th} phase region along the median radius rᵢ_{_{med}} is found as:

$${N}_{{MM}_{i}} = round \{ \frac{2 π {r}_{{i}_{med}}}{{L}_{Y}} \} \qquad ( 3 )$$

The angular spacing Δφᵢ in radians and the linear separation L_{Δφ}_{ᵢ} of the arrays tangential to the median radius rᵢ_{_{med}} is within the i^{th} phase region are defined respectively as:

$${Δφ}_{i} = \frac{2 π}{{N}_{{MM}_{i}}} \qquad ( 4 )$$

$${L}_{{Δφ}_{i}} = \frac{2 π {r}_{{i}_{med}}}{{N}_{{MM}_{i}}} \qquad ( 5 )$$

As shown in FIG. 8, azimuthal placement of arrays at equal linear spacings L_{Δφ}_{ᵢ} along the median radius rᵢ_{_{med}} of the phase region 110 will result in reduced linear spacings between the arrays towards the inner radius rᵢ_{ₘᵢₙ} and to an increased linear arrays' spacing towards the outer radius rᵢ_{ₘₐₓ}. Changes in arrays' spacings over the phase regions depend on the regions' numbers, i.e. the regions' locations over the lens aperture. FIG. 9 presents the changes in arrays' lateral spacings within the phase regions tangential to the inner rᵢ_{ₘᵢₙ} and the outer rᵢ_{ₘₐₓ} region radii as a function of the phase region number. Except for the regions 1 through 5 the changes in spacing of the arrays are less than 5%. For regions 10 through 27 the changes in spacings are less than 3%.

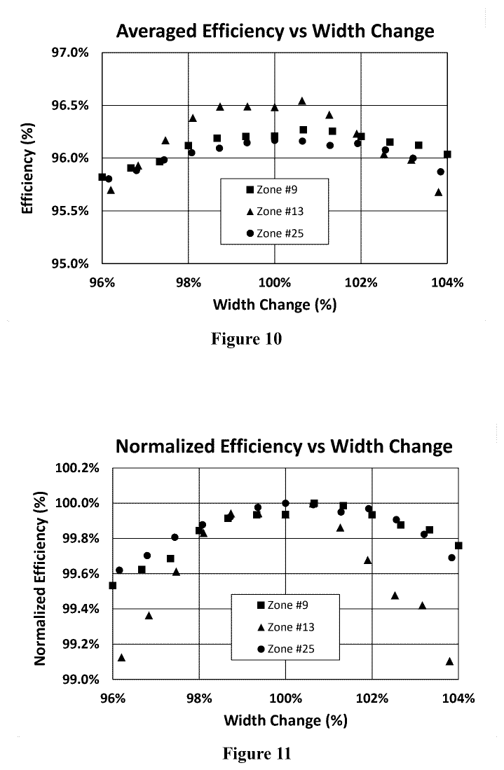

Effect of the spacings' changes between azimuthally arranged arrays within the phase regions onto the diffraction efficiencies of the regions can be estimated by analyzing sensitivities of the optimized arrays' diffraction efficiencies to the changes in the arrays' width. The following analysis was performed for the sample phase regions 9, 13, and 25 composed of optimized arrays designed for operation at the wavelength of λ=1.55 microns with the respective nominal region widths d₉=3.31 microns, d₁₃=2.84 microns, and d₂₅=2.25 microns. The optimized arrays are composed of Si subwavelength structures fabricated onto an SiO₂ substrate. The thickness of the Si layer that defines the height of the Si subwavelength structures is t=0.8 microns. FIG. 10 presents changes in averaged absolute diffraction efficiencies of optimized arrays for optimized phase regions 9, 13, and 25 as a function of the arrays' widths changes. FIG. 11 presents changes in averaged normalized diffraction efficiencies of optimized arrays for optimized phase regions 9, 13, and 25 as a function of the array's width changes. Based on the results shown in FIGS. 10 and 11, the changes in diffraction efficiencies of the phase regions do not exceed 0.5%.

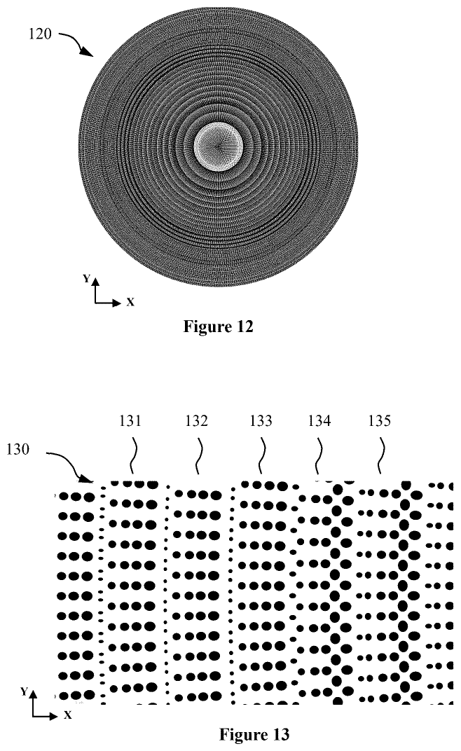

FIG. 12 presents an X-Y view of a diffractive lens 120 of the first embodiment, where the phase regions of the lens are populated with optimized arrays of subwavelength structures. The individual subwavelength structures contained within the diffractive lens cannot be resolved in FIG. 12. FIG. 13 presents a smaller fragment 130 of the diffractive phase lens 120 in FIG. 12, where the individual phase regions 131 through 135 are populated with optimized arrays containing different arrangements of subwavelength structures.

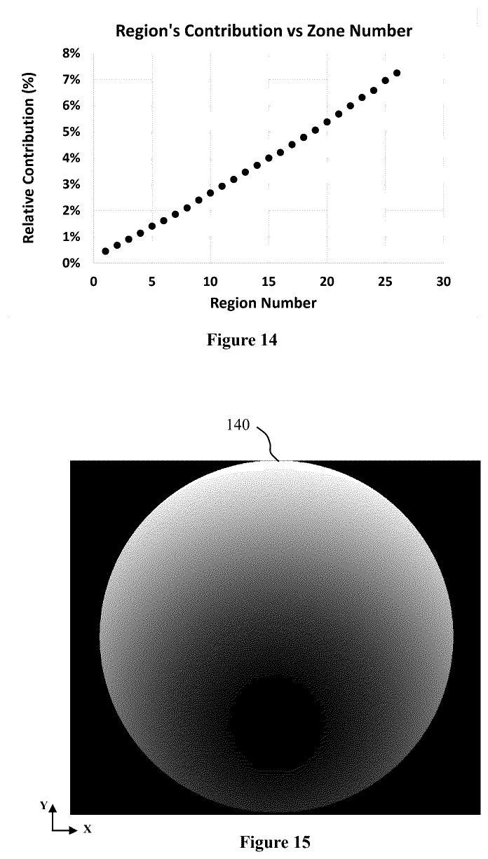

It is important to notice that contributions from different phase regions to the integral diffraction efficiency of the diffractive lens are different. A phase region contribution to the lens diffraction efficiency depends on the region's efficiency, the region areas and the power density of incident light over the region area. For a top-hat-shaped incident light, i.e. incident light with uniform intensity distribution across the entire lens aperture area, the relative contributions from different phase regions to the integral diffraction efficiency of the lens monotonically increase with the increase in the phase region's number, as shown in FIG. 14.

A diffractive phase lens design approach using phase regions comprised of optimized arrays of subwavelength structures can be also applied to designing lenses when the lens aperture is offset from the center of the axially-symmetric lens phase distribution. FIG. 15 presents a two-dimensional axially symmetric phase distribution in the X-Y plane for a diffractive lens, when the center of the lens aperture 140 is offset from the center of the phase distribution by −0.05 mm in Y-axis direction.

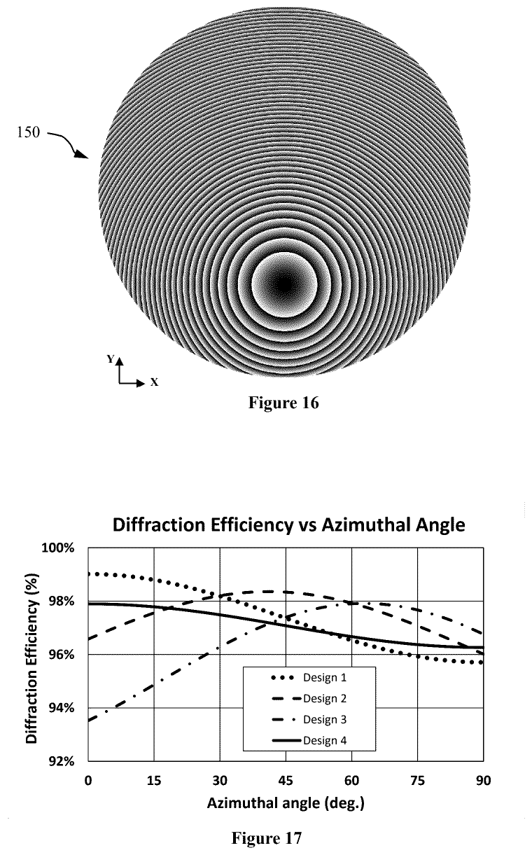

FIG. 16 presents an X-Y view of a two-dimensional distribution in the X-Y plane of the lens phase regions 150 corresponding to the phase distribution in FIG. 15, when the lens aperture was offset from the center of the phase distribution. Phase transitions at the boundaries of each of the region correspond to 2π radians optical phase change for the operating wavelength λ. Several of the phase regions in FIG. 16 are no longer circular in shape. The optimized arrays are arranged within the lens phase regions shown in FIG. 16 at equal azimuthal intervals, as defined by equation (4).

### Embodiment 2

The second embodiment presents design of a diffractive phase lens with axially symmetric phase distribution optimized for operation at a single polarization state of incident light. The lenses can de optimized for different polarization states of incident light, including linear, circular, or elliptical polarization. Lens performance optimization for a specific polarization state of light may result in additional increase in diffraction efficiency of the lens, as compared to a lens optimized for un-polarized incident light. The diffractive lens of the second embodiment has the same optical characteristics as the lens described in the first embodiment, i.e. it is designed for operation at the operating wavelength of λ=1.55 microns, has effective focal length EFL=0.1 mm, and aperture diameter D_{L}=0.1 mm. Therefore, the lens of the second embodiment has the same number of phase regions with the same region sizes as the phase regions of the first embodiment. Improved diffraction efficiency of the optimized arrays for the lens phase regions of the second embodiment is demonstrated for a linearly-polarization incident light. Design of optimized arrays of subwavelength structures within each ring-shaped phase region depends on azimuthal orientations of the arrays' axes with respect to the polarization plane of incident light. FIG. 17 presents changes in the diffraction efficiencies of different optimized arrays of subwavelength structures as a function of the azimuthal angle between the polarization plane of the incident plane-polarized light and the arrays' radial orientations. The exemplary array designs presented in FIG. 17 were optimized for the lens phase region 13. A similar optimization approach can be applied to other lens phase regions. Design 1, denoted by a dotted line in FIG. 17, has the highest diffraction efficiencies for azimuthal angles between 0 and 30 degrees. Design 2, denoted by a dashed line in FIG. 17, has the highest diffraction efficiencies for azimuthal angles between 30 and 60 degrees. Design 3, denoted by a dot-dashed line in FIG. 17, has the highest diffraction efficiencies for azimuthal angles between 60 and 90 degrees. Design 4, denoted by a solid line in FIG. 17 and presented as a reference, was optimized for un-polarized incident light.

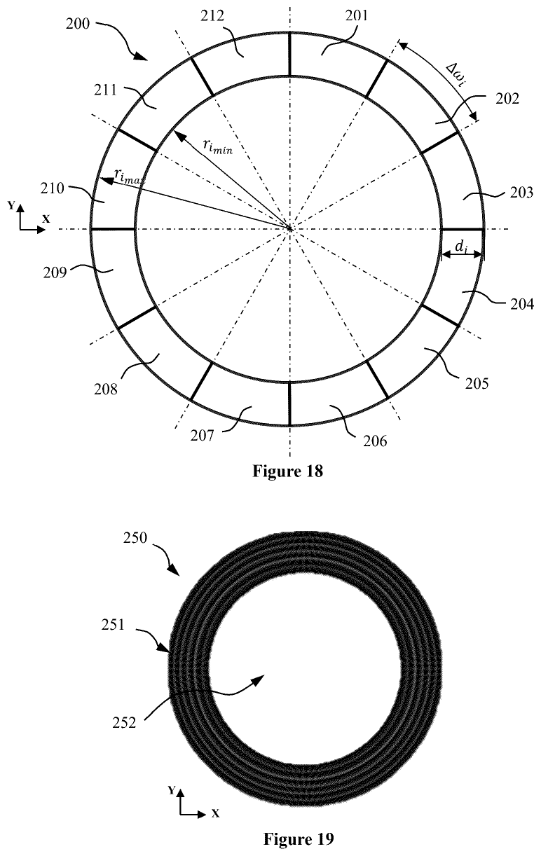

FIG. 18 presents a schematic layout in the X-Y plane of Cartesian coordinate system for a lens phase region 200 optimized for plane-polarized incident light. The region 200 in FIG. 18 corresponds to lens phase region 13. Layout of the phase region 200 is produced using optimized array designs 1, 2 and 3 with performance characteristics shown in FIG. 17. The lens phase region 200 has the outer radius rᵢ_{ₘₐₓ}, the inner radius rᵢ_{ₘᵢₙ} and the radial distance dᵢ defined by equation (2). The region 200 is divided into individual sectors 201 through 212. Each sector angular size Δωᵢ is 30 degrees and corresponds to azimuthal angles where the optimized array designs 1, 2 and 3 have the highest diffraction efficiencies. Different angular ranges for the optimized array designs can be required for other lens phase regions and array designs. Axial phase region's symmetry allows to reduce the number of optimized array designs composing the lens phase region. When the plane of polarization of the incident light is oriented along the X axis of the coordinate system, segments 203, 204, 209 and 210 of the phase region 200 will contain optimized arrays corresponding to Design 1, region segments 202 and 208 of the phase region 200 will contain optimized arrays corresponding to the design 2, and region segments 201, 206, 207 and 212 of the phase region 200 will contain optimized arrays corresponding to the design 3. Phase regions 205 and 211 will contain optimized arrays corresponding to another design, not shown in FIG. 17. Optimized array designs will have their lengths equal to dᵢ, will be radially oriented in the X-Y plane towards the center, and will be laterally spaced at equal azimuthal intervals within their respective sectors of the phase region 200, as defined by equations (4) and (5). The number of optimized arrays contained within the sectors of the phase region 200 will be different, as the optimized array designs have different width values. By using the 3 optimizing array designs for construction of the region 13, an additional 1.1% increase in diffraction efficiency of the phase region was achieved as compared to the region comprised of arrays optimized for polarization-independent incident light.

It may be desirable to design diffractive phase lenses that do not contain subwavelength structures within the central region of the lenses. FIG. 19 schematically shows a phase lens 250 with ring-shaped phase region 251. Central region 252 of the lens 250 does not contain subwavelength structures. The central region 252 can be made transparent to light propagating through the lens substrate. Alternatively, the centrals region 252 can be made to block the incident light. That can be achieved, for example, by applying light absorbing or reflecting coatings to the substrate at the lens central region 252.

### Embodiment 3

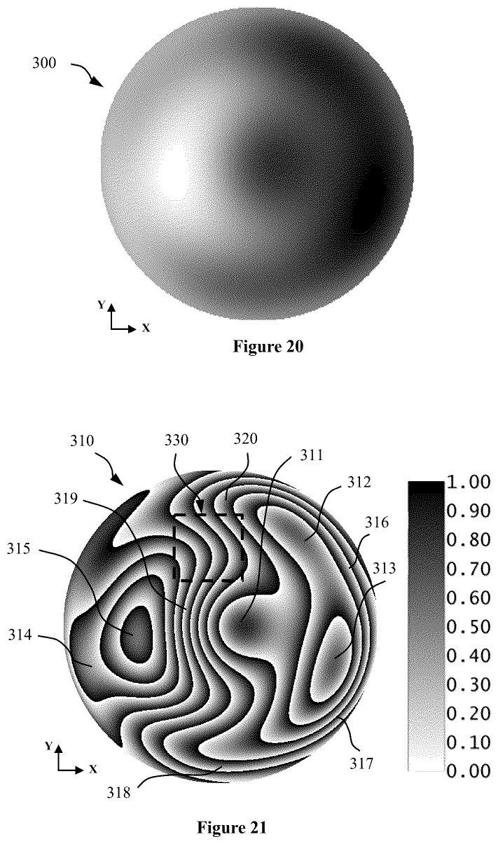

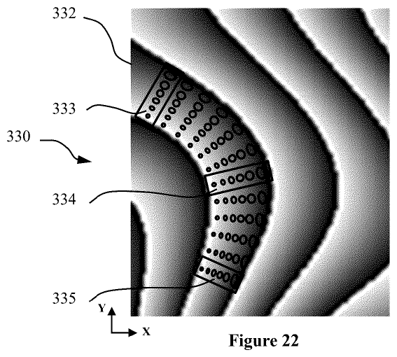

The third embodiment presents the design of a diffractive phase lens when the lens phase profile is not axially symmetric. FIG. 20 presents a two-dimensional phase profile 300 in the X-Y plane for a diffractive phase lens with no axial symmetry. The phase profile in FIG. 20 can be further converted into the individual lens phase regions. FIG. 21 presents a two-dimensional distribution of phase regions 310 in the X-Y plane that correspond to that of the diffractive phase profile 300 in FIG. 20. Phase transitions between the neighboring phase regions for the operating wavelength λ=1.55 microns in FIG. 21 occur at phase increments of 2mπ radians, where m is an integer number. The multiple m is often selected to be m=1, so that the phase increments between the neighboring phase regions is 2π radians, as shown in FIG. 21. The phase regions in FIG. 21 are no longer axially symmetric, and have complex shapes with varying sizes. Areas 311 through 315 of the phase regions 310 define locations of relatively small phase gradients, i.e. the areas where the local phase exhibits small changes across the phase regions. The local region sizes dᵢ within the areas 311 through 315 of the phase regions 310 are relatively large, typically more than 10 times the size of the operating wavelength λ, i.e. dᵢ>101. The areas 311 through 315 of the phase regions 310 can be designed and populated with individual subwavelength structures based on the periodic cell approximation (PCA). Areas 316 through 320 of the phase regions 310 define locations of large phase gradients, i.e. the areas where the local phase exhibits significant changes across the phase regions. The local region sizes dᵢ within the areas 316 through 320 of the phase regions 310 are relatively small, typically equal to, or less than 10 times the operating wavelength λ, i.e. dᵢ≤101. The areas 316 through 320 of the phase regions 310 will be designed in accordance with the design technique of the present invention using optimized arrays of subwavelength structures. Different arrays will be aligned within the areas 316 through 320 of the phase regions 310 with their lengths along the local phase gradients' directions, will have lengths equal the local phase regions' sizes measured along the phase gradients' directions, and will be laterally spaced within the phase regions at distances approximating the optimized widths of the respective arrays. Because the areas 316 through 320 of the phase regions 310 have variable local sizes, the lengths of the individual optimized arrays aligned within the phase regions along the phase gradient directions will also vary across the phase regions.

FIG. 22 presents a smaller area 330 of the lens phase regions 310. While all phase regions in FIG. 22 contain subwavelength structures, only a single region 332 is shown schematically as containing arrays of subwavelength structures. The region 332 in FIG. 22 contains several arrays of subwavelength structures having different sizes, including exemplary arrays 333 through 335. Arrays 333 through 335 have different azimuthal orientations, have their lengths aligned along the local phase gradients within the phase region 332, and have their lengths equal to the dimensions of the phase region 332 measured along the local phase gradients of the region.

### REFERENCES

1. Y. Soskind, “Field Guide to Diffractive Optics”, SPIE Press, 2011, page 92
2. B. Kress and P. Meyrueis, “Digital Diffractive Optics. An Introduction to Planar Diffractive Optics and Related Technology”, John Wiley & Sons, 2000, pp. 119-120
3. S.-W. Moon, et al. “Tutorial on metalenses for advanced flat optics: design, fabrication, and critical considerations.” Journal of Applied Physics 131.9 (2022)
4. US Patent Application 2023/0176366 “System and Method Designing Metalens”
5. US Patent Application 2023/0367114 “Automated Metalens Design System”
6. M. Chalony, et al. “Optical and manufacturing design aware flow for metalenses.” Advanced Materials, Biomaterials, and Manufacturing Technologies for Security and Defence. Vol. 12741. SPIE, 2023
7. L. S. Melvin III, et al. “Metalens manufacturing complexities and costs.” Advanced Etch Technology and Process Integration for Nanopatterning XIII. Vol. 12958. SPIE, 2024
8. V. Egede Johansen, et al., “Nanoscale precision brings experimental metalens efficiencies on par with theoretical promises.” Communications Physics 7.1 (2024): 123
9. U.S. patent application Ser. No. 18/919,973|95500-006US1: DIFFRACTION GRATING DESIGN TECHNIQUES AND ARRANGEMENTS USING SUB-WAVELENGTH STRUCTURES filed with US PTO on Oct. 24, 2024.

1. A diffractive lens, comprising:
a supporting substrate;
a plurality of phase regions defined on the supporting substrate, each of the phase regions including arrays of sub-wavelength structures, said arrays each having a length and width;
wherein said arrays in each region are aligned with their lengths extending in a direction in which phase changes occur across the diffractive lens;
wherein the lengths of the arrays are equal to a length of the regions in which the arrays are respectively located, the lengths of the phase regions being in the direction in which the phase changes occur across the diffractive lens.

2. A diffractive lens in accordance with claim 1, wherein said arrays are designed to produce required diffraction efficiencies.

3. A diffractive lens in accordance with claim 1, wherein said arrays are designed to satisfy manufacturability requirements.

4. A diffractive lens in accordance with claim 1, wherein said arrays are laterally spaced within the regions in which the arrays are respectively located at distances corresponding to an optimal width of the respective arrays.

5. A diffractive lens in accordance with claim 1, wherein said arrays within different regions contain different numbers of sub-wavelength structures.

6. A diffractive lens, comprising:
a supporting substrate;
a plurality of concentric regions defined on the substrate, wherein each of the concentric regions include arrays of sub-wavelength structures, said arrays each having a length and width;
wherein said arrays are oriented within the respective concentric regions with the lengths of the arrays being aligned radially towards a center of the respective concentric region in which the arrays are located; and
wherein the lengths of the arrays are equal to a length in the radial direction of the respective concentric regions in which the arrays are located.

7. A diffractive lens in accordance with claim 6, wherein said arrays are designed to produce required diffraction efficiencies.

8. A diffractive lens in accordance with claim 6, wherein said arrays are designed to satisfy manufacturability requirements.

9. A diffractive lens in accordance with claim 6, wherein said arrays are spaced apart from one another in an azimuthal direction.

10. A diffractive lens in accordance with claim 9, wherein said arrays are equally spaced apart from one another in an azimuthal direction.

11. A diffractive lens in accordance with claim 6, wherein said arrays in different ones of the concentric phase regions include different numbers of sub-wavelength structures within different ones of the concentric phase regions.

12. A diffractive lens in accordance with claim 6, wherein said concentric phase regions include a plurality of sectors, different ones of the sectors including different types of arrays azimuthally arranged within the sectors.

13. The diffractive lens in accordance with claim 12, wherein said arrays are arranged within the sectors at equal angular intervals.

14. The diffractive lens in accordance with claim 12, wherein said sectors are designed to produce required diffraction efficiencies for a particular polarization of light.

15. A diffractive lens in accordance with claim 6, wherein said lens does not contain subwavelength structures within a center region of the lens.

16. A diffractive lens in accordance with claim 15, wherein said center region contains means to block incident light from getting through the lens.

17. A method of designing diffractive lenses containing subwavelength structures, comprising:
evaluating the performance requirements for a lens;
selecting a lens substrate and layer materials and thicknesses for the subwavelength structures;
dividing the lens phase profile into individual phase regions;
determining dimensions of said phase regions in a direction of local phase changes;
defining arrays of the subwavelength structures having lengths equal to said dimensions of the phase regions;
optimizing said arrays of subwavelength structures to satisfy performance and manufacturability requirements,
selecting the optimized arrays that most closely satisfy the desired performance and manufacturability, and
establishing a layout for the diffractive lens by populating said phase regions with the selected optimized arrays.

18. A method of designing diffractive lenses in accordance with claim 17, wherein phase differences between adjacent ones of the phase regions are a multiple of 2π radians.

19. A method of designing diffractive lenses in accordance with claim 17, wherein said performance requirements correspond to a highest lens efficiency.

20. A method of designing diffractive lenses in accordance with claim 17, wherein said performance requirements correspond to a lowest lens back reflection.
